(19) United States
(12) Patent Application Publication
(10) Pub. No.: US 2008/0256269 A1
(43) Pub. Date: Oct. 16, 2008

(54) Path Assignment Method in Consideration of I/O Characteristics

(76) Inventor: Kazuo Ookubo, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/971,381

(22) Filed: Jan. 9, 2008

(30) Foreign Application Priority Data
Apr. 16, 2007 (JP) 2007-106975

(51) Int. Cl. G06F 3/00

(52) U.S. Cl. 710/38

(57) ABSTRACT

A computer system includes a plurality of host computers, at least one storage system coupled to the plurality of host computers through a plurality of paths, and a management computer, in which each of the plurality of host computers executes at least one application program which issues an I/O to the storage system, and the management computer obtains a characteristic of the application program and a characteristic of the path from the plurality of host computers and calculates a rate of assignment of data processed by the application program to each of the plurality of host computers based on the obtained characteristics of the application program and the path.

### CLAIM OF PRIORITY

The present application claims priority from Japanese patent application P2007-106975 filed on Apr. 16, 2007, the content of which is hereby incorporated by reference into this application.

### BACKGROUND

The present invention relates to a computer system including a plurality of host computers, at least one storage system, and a management computer, in particular, a load balancing technique.

There is known a multi-path computer system disclosed in Japanese Patent Application Laid-open No. 2005-10956. The multi-path computer system includes a storage system and a host computer. The storage system and the host computer are connected through a plurality of paths.

The host computer executing an application program selects a path according to a round-robin method and uses the selected path to transmit an input/output request (hereinafter, referred to simply as “I/O”) issued from the application program.

Japanese Patent Application Laid-open No. 2005-259155 discloses a method of balancing workloads among paths in a multi-path computer system.

Moreover, a computer system including a plurality of host computers, on which the same application program is installed, is known. The computer system is operated as a cluster configuration.

### SUMMARY

In the conventional multi-path computer systems, the host computer does not take path characteristics into consideration and equally uses all the paths to transmit the I/Os. Therefore, the conventional multi-path computer systems suffer from inefficient use of the paths. The path characteristics herein include a line capacity, a response speed and a reliability.

Moreover, in the conventional multi-path computer systems, the host computer does not take characteristics of the application program corresponding to an I/O issuing source into consideration and transmits I/Os in the order of issuance. Therefore, an I/O to be transmitted by priority is disadvantageously delayed.

Furthermore, in the computer system operated as the cluster configuration, application program characteristics and path characteristics are not taken into consideration. Therefore, in the computer system, data processed by the application program cannot be assigned to a suitable host computer.

The present invention is devised in view of the above-described problems and has an object of providing a computer system which assigns data processed by an application program to a suitable host computer.

According to an exemplary embodiment of this invention, there is provided a computer system, comprising: a plurality of host computers, each including a processor, a memory, and an interface; at least one storage system coupled to the plurality of host computers through a plurality of paths; and a management computer including a processor, a memory, and an interface, the management computer being able to access the plurality of host computers, wherein: each of the plurality of host computers executes at least one application program that issues an I/O to the storage system; and the management computer obtains a characteristic of the application program and a characteristic of the path from the plurality of host computers, and calculates a rate of assignment of data processed by the application program to each of the plurality of host computers based on the obtained characteristic of the application program and the obtained characteristic of the path.

According to a representative aspect of the present invention, data processed by an application program can be assigned to a suitable host computer.

### BRIEF DESCRIPTION OF THE DRAWINGS

The present invention can be appreciated by the description which follows in conjunction with the following figures, wherein:

FIG. 1 is a block diagram of a configuration of a computer system according to an embodiment of the present invention;

FIG. 2 is a configuration diagram of a host information table stored in a management server according to the embodiment of the present invention;

FIG. 3 is a configuration diagram of a physical path information table stored in the management server according to the embodiment of the present invention;

FIG. 4 is a configuration diagram of a intra-host a application load information table stored in the management server according to the embodiment of the present invention;

FIG. 5 is a configuration diagram of a task application load information table stored in the management server according to the embodiment of the present invention;

FIG. 6 is a configuration diagram of a physical path load information table stored in the management server according to the embodiment of the present invention;

FIG. 7A is configuration diagram of a counter value management table stored in the host computer according to the embodiment of the present invention;

FIG. 7B is configuration diagram of the counter value management table stored in the host computer according to the embodiment of the present invention;

FIG. 8 is a flowchart of a feature determining process executed by the management server according to the embodiment of the present invention;

FIG. 9 is a flowchart of a data assignment rate determining process executed by the management server according to the embodiment of the present invention;

FIG. 10 is a flowchart of a counter upper limit values calculating process executed by the management server according to the embodiment of the present invention;

FIG. 11 is a flowchart of a intra-host task application load information table creating process executed by the management server according to the embodiment of the present invention; and

FIG. 12 is a flowchart of an I/O transmitting process executed by the host computer according to the embodiment of the present invention.

### DETAILED DESCRIPTION OF THE PREFERRED EMBODIMENT

Hereinafter, an embodiment of the present invention will be described with reference to the accompanying drawings.

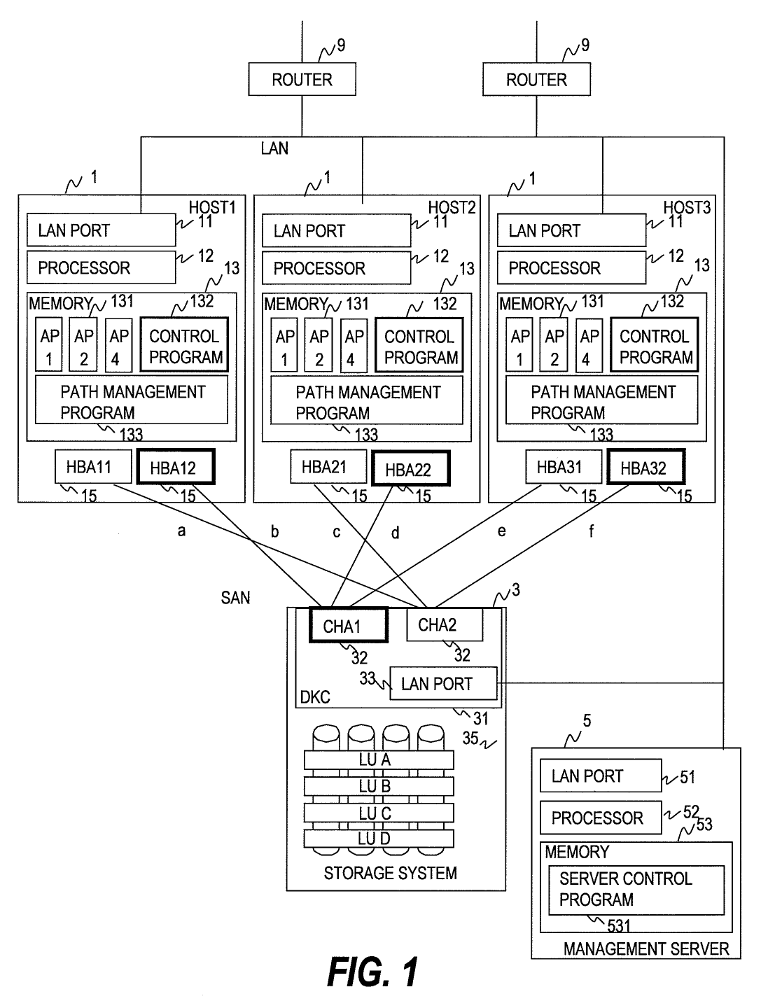

FIG. 1 is a block diagram of a configuration of a computer system according to an embodiment of the present invention.

The computer system includes host computers 1, a storage system 3 and a management server 5.

Each of the host computers 1 and the storage system 3 are connected to each other through a physical path. Alternatively, the host computer 1 and the storage system 3 may be connected to each other through a logical path instead of the physical path. Redundancy is provided for the logical path according to the combination of physical paths.

The host computers 1, the storage system 3 and the management server 5 are connected to each other through the LAN.

Although three host computers 1 are illustrated in FIG. 1, the computer system may include any number of host computers 1. Similarly, although the computer system illustrated in FIG. 1 includes only one storage system 3, the computer system may include any number of storage systems 3.

The storage system 3 includes a disk controller (DKC) 31 and a physical disk 35.

The disk controller 31 reads and writes data to/from the physical disk 35. The disk controller 31 also provides a storage area of the physical disk 35 to the host computer 1 as a logical unit (LU).

The disk controller 31 includes channel adapters (CHAs) 32 and a LAN port 33. Although the disk controller 31 is illustrated to include two CHAs 32, the disk controller 31 may include any number of CHAs 32.

Each of the CHAs 32 is an interface connected to a host bus adapter (HBA) 15 provided for the host computer 1 through the physical path. Each of the CHAs 32 includes a CPU, a memory and a CHA port to control data transfer to/from the host computer 1. In FIG. 1, the CHAs 32 having higher reliability are indicated by heavy lines. For example, the level of reliability of the CHA 32 is determined based on whether or not the CHA 32 has an error correction coding (ECC) function.

The LAN port 33 is an interface connected to the management server 5 through the LAN.

The host computer 1 makes a request of reading and writing data to the storage system 3. The host computer 1 includes a LAN port 11, a processor 12, a memory 13 and the HBAs 15. Although each host computer 1 includes two HBAs 15 in FIG. 1, the host computer 1 may include any number of HBAs 15.

The LAN port 11 is an interface connected to the management server 5 through the LAN. The LAN port 11 is connected to the Internet or the Intranet through the LAN.

The Internet or the Intranet includes at least one router 9 and a client computer (not shown). The router 9 controls data transfer. The client computer makes a data processing request to task application programs 131 installed on the host computer 1.

The HBA 15 is an interface connected to the CHA 32 provided for the storage system 3 through the physical path. In FIG. 1, the HBAs 15 having higher reliability are indicated by heavy lines. For example, the level of reliability of the HBA 15 is determined based on whether or not the HBA 15 has an ECC function.

The processor 12 executes a program stored in the memory 13 to perform various processes.

The memory 13 stores the program executed by the processor 12 and information required by the processor 12. More specifically, the memory 13 stores the task application programs (APs) 131, a control program 132, and a physical path management program 133. Although the memory 13 includes three task application programs 131 in FIG. 1, the memory 13 may store any number of task application programs 131.

The task application program 131 executes a process for various tasks. The LAN receives data processed by the task application program 131 from the Internet or the Intranet. The task application program 131 receives data through the LAN from the Internet or the Intranet to process the received data. Then, the task application program 131 issues an input/output request (hereinafter, referred to simply as “I/O”) to the storage system 3.

The control program 132 measures an I/O amount and the count of I/Os issued from the task application program 131. The control program 132 also measures an I/O amount and the count of I/Os transmitted by using each of the physical paths connected to the host computer 1.

The physical path management program 133 has a load balance function. Specifically, the physical path management program 133 assigns the I/Os issued from the task application program 131 to different physical paths to distribute the load over the physical paths.

When a failure occurs in the physical path, the physical path management program 133 blocks the physical path in which the failure occurs. As a result, the physical path management program 133 does not use the physical path in which the failure occurs to transmit the I/O. In this case, the physical path management program 133 transmits the I/O by using an unblocked physical path.

The physical path management program 133 executes a failure detection process (path health check) of the physical path.

More specifically, the physical path management program 133 uses the physical path whose status is desired to be checked to transmit a SCSI INQUIRY command as a failure detection signal (connection confirmation signal) to the storage system 3. Then, the physical path management program 133 determines a status of the physical path based on whether or not the failure detection signal has been successfully transmitted. More specifically, when the failure detection signal has been successfully transmitted, the physical path management program 133 determines that the physical path is normal. On the other hand, if not, the physical path management program 133 determines that a failure occurs in the physical path.

Furthermore, the memory 13 stores counter value management tables 137 respectively corresponding to the physical paths connected to the host computer 1. Therefore, the host computer 1 stores the counter value management tables 137 as many as the physical paths connected to the host computer 1.

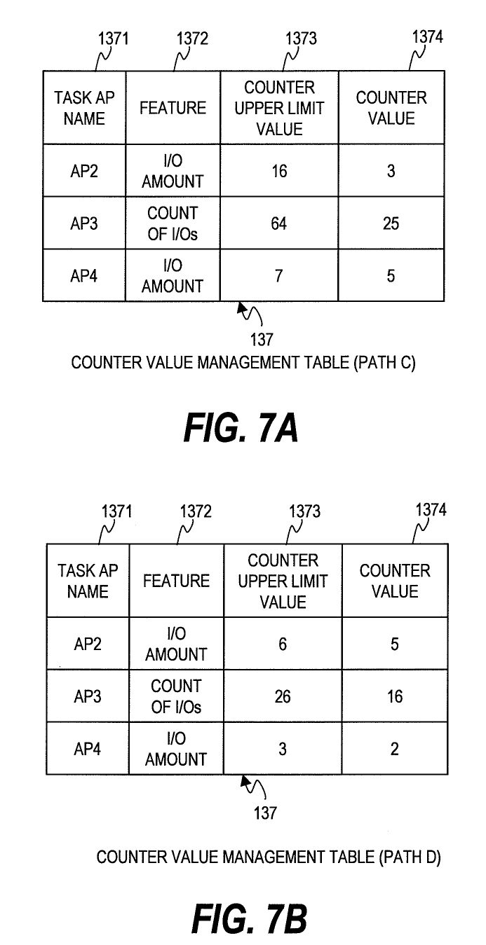

The counter value management table 137 manages information for determining the order of transmission of I/Os issued from the task application program 131. The counter value management tables 137 will be described in detail below with reference to FIGS. 7A and 7B.

The host computer 1 has a queue for each of the task application programs 131 provided for the host computer 1. The queue temporarily stores the I/Os issued from the task application program 131 corresponding to the queue. Therefore, the I/Os issued from the task application program 131 are stored in the queue corresponding to the task application program 131.

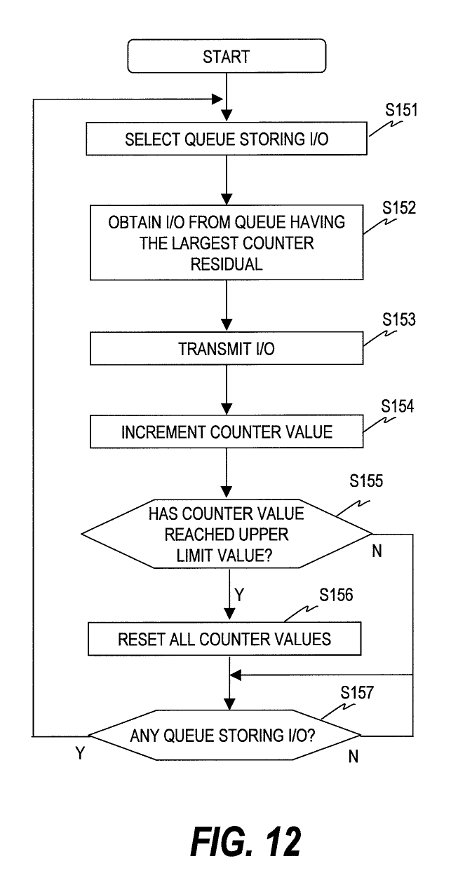

The physical path management program 133 refers to the counter value management table 137 to select any of the queues provided for the host computer 1. Next, the physical path management program 133 extracts I/Os from the selected queue. Then, the physical path management program 133 transmits the extracted I/Os from the physical path. An I/O transmitting process executed by the physical path management program 133 will be described in detail below with reference to FIG. 12.

The management server 5 is a computer which controls the whole computer system. The management server 5 includes a LAN port 51, a processor 52 and a memory 53.

The LAN port 51 is an interface connected to the host computers 1 and the storage system 3 through the LAN.

The processor 52 executes a program stored in the memory 53 to perform various processes.

The memory 53 stores the program executed by the processor 52 and information required by the processor 52. More specifically, the memory 53 stores a server control program 531, a host information table 532, a physical path information table 534, an intra-host task application load information table 535, a task application load information table 533, and a physical path load information table 536.

The server control program 531 creates or updates the host information table 532, the physical path information table 534, the intra-host task application load information table 535, the task application load information table 533, and the physical path load information table 536.

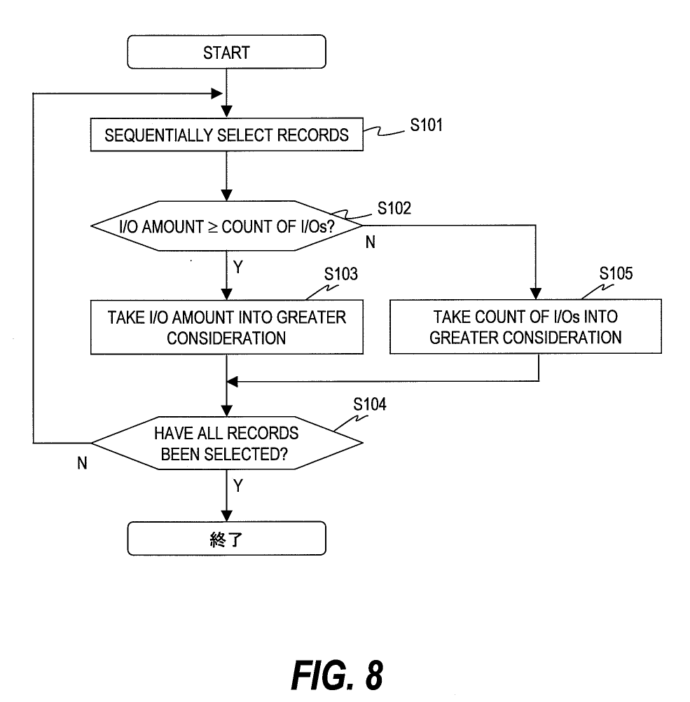

For the creation or update of the tables, the server control program 531 determines a feature of the task application program 131 and a feature of the physical path. A feature determining process executed by the server control program 531 will be described in detail below with reference to FIG. 8.

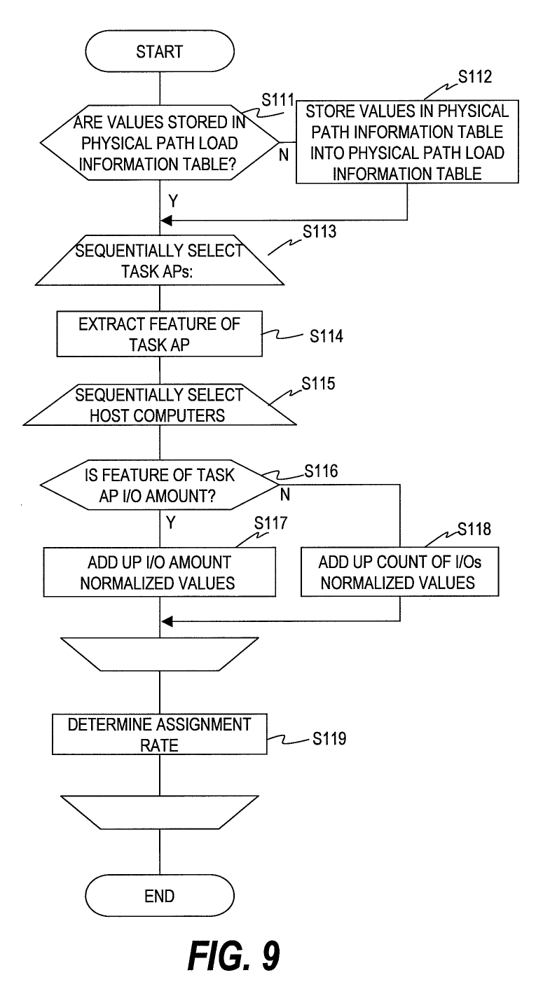

The server control program 531 determines the assignment of data processed by the task application program 131. Specifically, the server control program 531 determines to which host computer 1 and at what rate the data processed by the task application program 131 is assigned. A data assignment rate determining process executed by the server control program 531 will be described in detail below with reference to FIG. 9.

Then, the server control program 531 instructs the host computer 1, the router 9 or the client computer to assign the data at the determined assignment rate.

Upon reception of the assignment instruction, the host computer 1 transmits and receives the data to/from another one of the host computers 1 to achieve the instructed assignment rate. For example, of all the received data, the host computer 1 processes only the amount of data to be assigned to the host computer 1 by the task application program 131. Therefore, of all the received data, the host computer 1 transmits the amount of data to be assigned to the other host computers 1 to the other host computers 1.

Upon reception of the assignment instruction, the router 9 transfers the data processed by the task application program 131 to each of the host computers 1 to achieve the instructed assignment rate.

Upon reception of the assignment instruction, the client computer distributes the data processed by the task application program 131 to a plurality of the host computers 1 to achieve the instructed assignment rate.

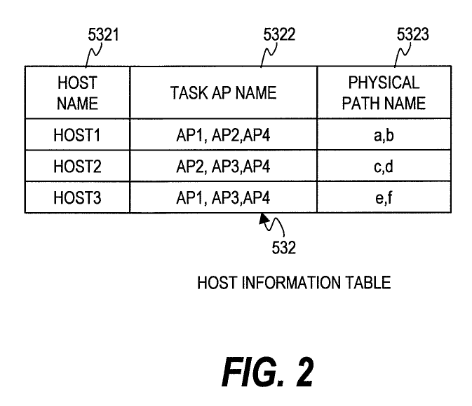

The host information table 532 shows the correspondence relation between the host computer 1 and the task application programs 131 installed on the host computer 1. Furthermore, the host information table 532 shows the correspondence relation between the host computer 1 and the physical paths connected to the host computer 1. The host information table 532 will be described in detail below with reference to FIG. 2.

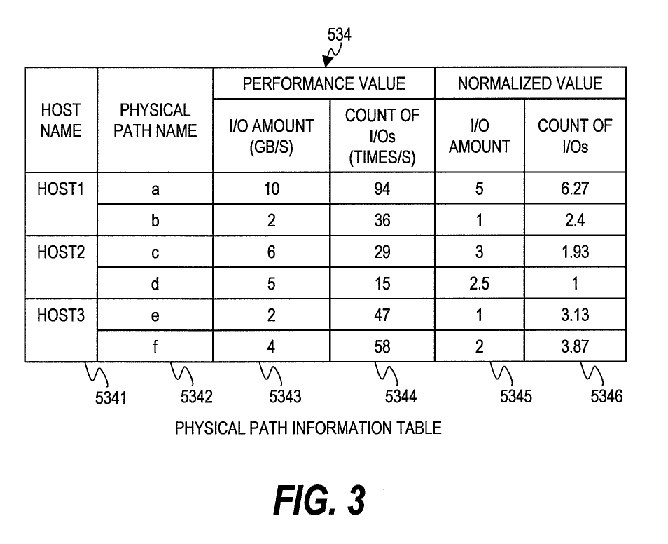

The physical path information table 534 shows information regarding the maximum performance of the physical path. The physical path information table 534 will be described in detail below with reference to FIG. 3.

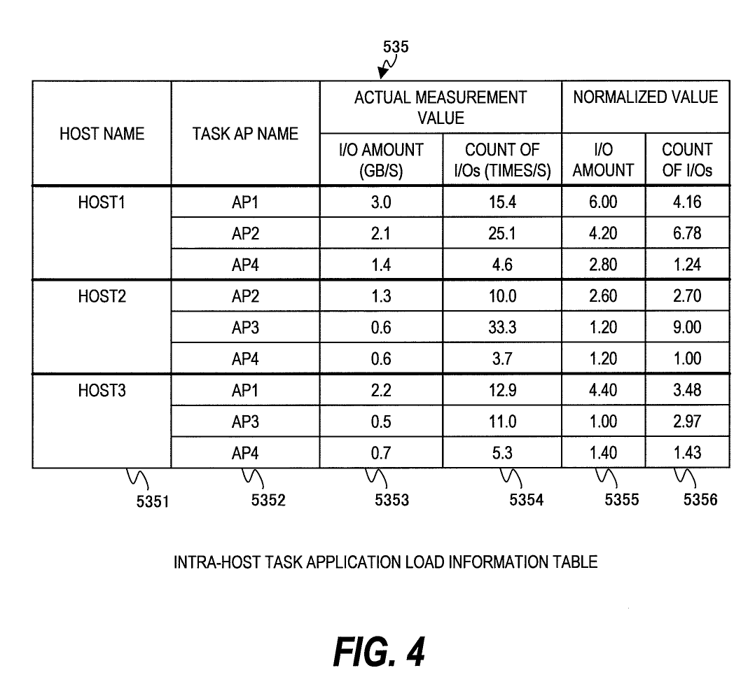

The intra-host task application load information table 535 manages information regarding a load on the task application program 131 for each of the task application programs 131 installed on each of the host computers 1. The intra-host task application load information table 535 will be described in detail below with reference to FIG. 4.

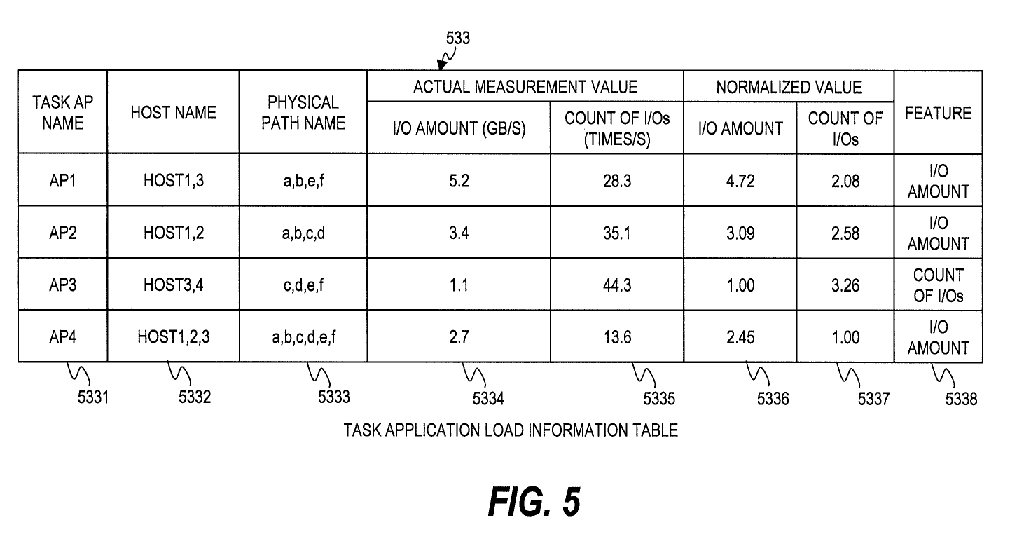

The task application load information table 533 manages the information regarding the load on the task application program 131 for each of the types of task application programs 131. The task application load information table 533 will be described in detail below with reference to FIG. 5.

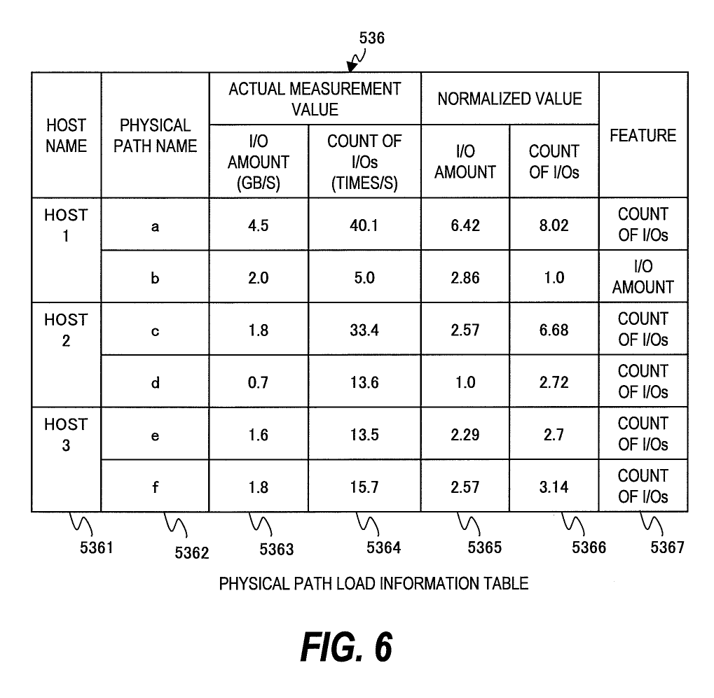

The physical path load information table 536 shows information regarding performance of the physical path during the operation of the computer system. The physical path load information table 536 will be described in detail below with reference to FIG. 6.

FIG. 2 is a configuration diagram of the host information table 532 stored in the management server 5 according to the embodiment of the present invention.

The host information table 532 contains a host name 5321, a task application name 5322 and a physical path name 5323.

The host name 5321 is a unique identifier of the host computer 1 managed by the management server 5.

The task application name 5322 is a unique identifier of the task application program 131 installed on the host computer 1 identified by the host name 5321 in the record. The physical path name 5323 is a unique identifier of the physical path connected to the host computer 1 identified by the host name 5321 in the record.

FIG. 3 is a configuration diagram of the physical path information table 534 stored in the management server 5 according to the embodiment of the present invention.

The physical path information table 534 contains a host name 5341, a physical path name 5342, a performance value of an I/O amount (hereinafter, referred to as an I/O amount performance value) 5343, a performance value of the count of I/Os (hereinafter, referred to as an I/O count performance value) 5344, a normalized value of the I/O amount (hereinafter, referred to as an I/O amount normalized value) 5345, and a normalized value of the count of I/Os (hereinafter, referred to as an I/O count normalized value) 5346.

The host name 5341 is a unique identifier of the host computer 1 managed by the management server 5. The physical path name 5342 is a unique identifier of the physical path connected to the host computer 1 identified by the host name 5341 in the record.

The I/O amount performance value 5343 is the largest value of an I/O amount transmittable per unit time from the physical path identified by the physical path name 5342 in the record. The I/O count performance value 5444 is the largest value of the count of I/Os transmittable per unit time from the physical path identified by the physical path name 5342 in the record.

As the I/O amount performance value 5343 and the I/O count performance value 5344, values measured for each physical path before the start of operation of the computer system are stored. Alternatively, values calculated based on the specifications of each physical path are stored respectively as the I/O amount performance value 5343 and the I/O count performance value 5344.

The I/O amount normalized value 5345 is a value obtained by normalizing the I/O amount performance value 5343 in the record. More specifically, the I/O amount normalized value 5345 indicates how many times the I/O amount performance value 5343 in the record is larger than the smallest value of the I/O amount performance values 5343 included in all the records. Specifically, the I/O amount normalized value 5345 indicates how many times the I/O amount performance value 5343 of the physical path identified by the physical path name 5342 in the record is larger than the smallest value of the I/O amount performance values 5343 of all the physical paths.

Therefore, the I/O amount normalized value 5345 in the record containing the smallest I/O amount performance value 5345 is “1”. Specifically, the I/O amount normalized value 5345 of the physical path having the smallest I/O amount performance value 5343 is “1”.

In the case of the configuration diagram in FIG. 3, “2” corresponding to the I/O amount performance value 5343 of the physical path identified by “b” or “e” corresponding to the physical path name 5342 is the smallest value. Therefore, the I/O amount normalized value 5345 is calculated by dividing the I/O amount performance value 5343 in the record by “2” corresponding to the smallest value.

The I/O count normalized value 5346 is obtained by normalizing the I/O count performance value 5344 in the record. More specifically, the I/O count normalized value 5346 indicates how many times the I/O count performance value 5344 in the record is larger than the smallest value of the I/O count performance values 5344 contained in all the records. Specifically, the I/O count normalized value 5346 indicates how many times the I/O count performance value 5344 of the physical path identified by the physical path name 5342 in the record is larger than the smallest value of the I/O count performance values 5344 of all the physical paths.

Therefore, the I/O count normalized value 5346 in the record containing the smallest I/O count performance 5344 is “1”. Specifically, the I/O count normalized value 5346 of the physical path having the smallest I/O count performance value 5344 is “1”.

In the case of the configuration diagram in FIG. 3, “15” corresponding to the I/O count performance value 5344 of the physical path identified by “d” corresponding to the physical path name 5342 is the smallest value. Therefore, the I/O count normalized value 5346 is calculated by dividing the I/O count performance value 5344 in the record by “15” corresponding to the smallest value.

FIG. 4 is a configuration diagram of the intra-host task application load information table 535 stored in the management server 5 according to the embodiment of the present invention.

The intra-host task application load information table 535 contains a host name 5351, a task application name 5352, an I/O amount actual measurement value 5353, an I/O count actual measurement value 5354, an I/O amount normalized value 5355, and an I/O count normalized value 5356.

The host name 5351 is a unique identifier of the host computer 1 managed by the management server 5. The task application name 5352 is a unique identifier of the task application program 131 installed on the host computer 1 identified by the host name 5351 in the record.

The I/O amount actual measurement value 5353 indicates an I/O amount issued per unit time from the task application program 131 identified by the task application name 5352 in the record among the task application programs 131 included in the host computer 1 identified by the host name 5351 in the record. The I/O count actual measurement value 5354 indicates the count of I/Os transmitted per unit time from the task application program 131 identified by the task application name 5352 in the record among the task application programs 131 included in the host computer 1 identified by the host name 5351 in the record.

The host computer 1 measures the I/O amount per unit time and the count of I/Os per unit time, issued from each of the task application programs 131 included in the host computer 1. Next, the host computer 1 transmits the measured I/O amount and count of I/Os to the management server 5. Then, the management server 5 stores the received I/O amount in the I/O amount actual measurement value 5353 in the intra-host task application load information table 535. Furthermore, the management server 5 stores the received count of I/Os in the I/O count actual measurement value 5354 in the intra-host task application load information table 535.

The I/O amount normalized value 5355 is obtained by normalizing the I/O amount actual measurement value 5353 in the record. More specifically, the I/O amount normalized value 5355 indicates how many times the I/O amount actual measurement value 5353 in the record is larger than the smallest value of the I/O amount actual measurement values 5353 contained in all the records. Specifically, the I/O amount normalized value 5355 indicates how many times the I/O amount actual measurement value 5353 of the task application program 131 identified by the task application name 5352 in the record is larger than the smallest value of all the I/O amount actual measurement values 5353 of the task application programs 131.

Accordingly, the I/O amount normalized value 5355 in the record containing the smallest I/O amount actual measurement value 5353 is “1”. Specifically, the I/O amount normalized value 5355 of the task application program 131 having the smallest I/O amount actual measurement value 5353 is “1”.

In the case of the configuration diagram shown in FIG. 4, a value “0.5” as the I/O amount actual measurement value 5353 of the task application program 131 identified by the task application name 5352, “AP3”, included in the host computer 1 identified by the host name 5351, “HOST3”, is the smallest. Therefore, the I/O amount normalized value 5355 is calculated by dividing the I/O amount actual measurement value 5353 in the record by “0.5” corresponding to the smallest value.

The I/O count normalized value 5356 is obtained by normalizing the I/O count actual measurement value 5354 in the record. More specifically, the I/O count normalized value 5356 indicates how many times the I/O count actual measurement value 5354 in the record is larger than the smallest value of the I/O count actual measurement values 5354 contained in all the records. Specifically, the I/O count normalized value 5356 indicates how many times the I/O count actual measurement value 5354 of the task application program 131 identified by the task application name 5352 in the record is larger than the smallest value of all the I/O count actual measurement values 5354 of the task application programs 131.

Accordingly, the I/O count normalized value 5356 in the record containing the smallest I/O count actual measurement value 5354 is “1”. Specifically, the I/O count normalized value 5356 of the task application program 131 having the smallest I/O count actual measurement value 5354 is “1”.

In the case of the configuration diagram shown in FIG. 4, “3.7” corresponding to the I/O count actual measurement value 5354 of the task application program 131 identified by the task application name 5352, “AP4”, included in the host computer 1 identified by the host name 5351, “HOST2”, is the smallest. Therefore, the I/O count normalized value 5356 is calculated by dividing the I/O count actual measurement value 5354 in the record by “3.7” corresponding to the smallest value.

FIG. 5 is a configuration diagram of the task application load information table 533 stored in the management server 5 according to the embodiment of the present invention.

The task application load information table 533 contains a task application name 5331, a host name 5332, a physical path name 5333, an I/O amount actual measurement value 5334, an I/O count actual measurement value 5335, an I/O amount normalized value 5336, an I/O count normalized value 5337, and a feature 5338.

The task application name 5331 is a unique identifier of the task application program 131 installed on the host computer 1.

The host name 5332 is a unique identifier of the host computer 1 on which the task application program 131 identified by the task application name 5331 in the record is installed. The physical path name 5333 is a unique identifier of the physical path available for the transmission of the I/Os issued from the task application program 131 identified by the task application name 5331 in the record.

The I/O amount actual measurement value 5334 is an I/O amount per unit time, issued from the task application programs 131 identified by the task application name 5331 in the record. The I/O count actual measurement value 5335 is the count of I/Os per unit time, which are issued from the task application program 131 identified by the task application name 5331 in the record.

The management server 5 calculates the I/O amount actual measurement value 5334 and the I/O count actual measurement value 5335 in the task application load information table 533 based on the intra-host task application load information table 535.

More specifically, the management server 5 sequentially selects all the records contained in the task application load information table 533 one by one. Next, the management server 5 extracts the task application name 5331 from the selected record. Then, the management server 5 selects all the records containing the task application name 5352 which is identical with the extracted task application name 5331 from the intra-host task application load information table 535. Subsequently, the management server 5 extracts the I/O amount actual measurement values 5353 and the I/O count actual measurement values 5354 from all the selected records.

Next, the management server 5 adds up all the extracted I/O amount actual measurement values 5353. Subsequently, the management server 5 stores the sum in the I/O amount actual measurement value 5334 in the record selected from the task application load information table 533. Next, the management server 5 adds up all the extracted I/O count actual measurement values 5354. Next, the management server 5 stores the sum in the I/O count actual measurement value 5335 in the record selected from the task application load information table 533.

Then, the management server 5 repeats the above-described process until all the records contained in the task application load information table 533 are selected.

The I/O amount normalized value 5336 is obtained by normalizing the I/O amount actual measurement value 5334 in the record. More specifically, the I/O amount normalized value 5336 indicates how many times the I/O amount actual measurement value 5334 in the record is larger than the smallest value of the I/O amount actual measurement values 5334 contained in all the records. Specifically, the I/O amount normalized value 5336 indicates how many times the I/O amount actual measurement value 5334 of the task application program 131 identified by the task application name 5331 in the record is larger than the smallest value of all the I/O amount actual measurement values 5334 of the task application programs 131.

Accordingly, the I/O amount normalized value 5336 in the record containing the smallest I/O amount actual measurement value 5334 is “1”. Specifically, the I/O amount normalized value 5336 of the task application program 131 having the smallest I/O amount actual measurement value 5334 is “1”.

In the case of the configuration diagram shown in FIG. 4, a value “1.1” as the I/O amount actual measurement value 5334 of the task application program 131 identified by the task application name 5331, “AP3”, is the smallest. Therefore, the I/O amount normalized value 5336 is calculated by dividing the I/O amount actual measurement value 5334 in the record by “1.1” corresponding to the smallest value.

The I/O count normalized value 5337 is obtained by normalizing the I/O count actual measurement value 5335 in the record. More specifically, the I/O count normalized value 5337 indicates how many times the I/O count actual measurement value 5335 in the record is larger than the smallest value of the I/O count actual measurement values 5335 contained in all the records. Specifically, the I/O count normalized value 5337 indicates how many times the I/O count actual measurement value 5335 of the task application program 131 identified by the task application name 5331 in the record is larger than the smallest value of all the I/O count actual measurement values 5335 of the task application programs 131.

Accordingly, the I/O count normalized value 5337 in the record containing the smallest I/O count actual measurement value 5335 is “1”. Specifically, the I/O count normalized value 5337 of the task application program 131 having the smallest I/O count actual measurement value 5335 is “1”.

In the case of the configuration diagram shown in FIG. 5, “13.6” corresponding to the I/O count actual measurement value 5335 of the task application program 131 identified by the task application name 5331, “AP4”, is the smallest. Therefore, the I/O count normalized value 5337 is calculated by dividing the I/O count actual measurement value 5335 in the record by “13.6” corresponding to the smallest value.

The feature 5338 indicates which of the I/O amount and the count of I/Os is taken into greater consideration by the task application program 131 identified by the task application name 5331 in the record. The I/O issued from the task application program 131 taking the I/O amount into greater consideration is transmitted from the host computer 1 to the storage system 3 by using the physical path taking the I/O amount into greater consideration by priority. On the other hand, the I/O issued from the task application program 131 taking the count of I/Os into greater consideration is transmitted from the host computer 1 to the storage system 3 by using the physical path taking the count of I/Os into greater consideration by priority.

A process in which the management server 5 determines the feature 5338 will be described in detail below with reference to FIG. 8.

FIG. 6 is a configuration diagram of the physical path load information table 536 stored in the management server 5 according to the embodiment of the present invention.

The physical path load information table 536 contains a host name 5361, a physical path name 5362, an I/O amount actual measurement value 5363, an I/O count actual measurement value 5364, an I/O amount normalized value 5365, an I/O count normalized value 5366, and a feature 5367.

The host name 5361 is a unique identifier of the host computer 1 managed by the management server 5. The physical path name 5362 is a unique identifier of the physical path connected to the host computer 1 identified by the host name 5361 in the record.

The I/O amount actual measurement value 5363 is the largest value of the I/O amount per unit time, transmitted from the physical path identified by the physical path name 5362 in the record. The I/O count actual measurement value 5364 is the largest value of the count of I/Os per unit time, which are transmitted from the physical path identified by the physical path name 5362 in the record.

The host computer 1 measures the I/O amount per unit time and the count of I/Os per unit time, which are transmitted by using each of the physical paths connected to the host computer 1. Next, the host computer 1 transmits the measured I/O amount and count of I/Os to the management server 5. Then, the management server 5 stores the received I/O amount as the I/O amount actual measurement value 5363 in the physical path load information table 536. The management server 5 also stores the received count of I/Os as the I/O count actual measurement value 5364 in the physical path load information table 536.

The I/O amount normalized value 5365 is obtained by normalizing the I/O amount actual measurement value 5363 in the record. More specifically, the I/O amount normalized value 5365 indicates how many times the I/O amount actual measurement value 5363 in the record is larger than the smallest value of the I/O amount actual measurement values 5363 contained in all the records. Specifically, the I/O amount normalized value 5365 indicates how many times the I/O amount actual measurement value 5363 of the physical path identified by the physical path name 5362 in the record is larger than the smallest value of all the I/O amount actual measurement values 5353 of the physical path.

Accordingly, the I/O amount normalized value 5365 in the record containing the smallest I/O amount actual measurement value 5363 is “1”. Specifically, the I/O amount normalized value 5365 of the physical path having the smallest I/O amount actual measurement value 5363 is “1”.

In the case of the configuration diagram shown in FIG. 6, a value “0.7” corresponding to the I/O amount actual measurement value 5363 of the physical path identified by “d” as the physical path name 5362 is the smallest value. Therefore, the I/O amount normalized value 5365 is calculated by dividing the I/O amount actual measurement value 5363 in the record by “0.7” corresponding to the smallest value.

The I/O count normalized value 5366 is obtained by normalizing the I/O count actual measurement value 5364 in the record. More specifically, the I/O count normalized value 5366 indicates how many times the I/O count actual measurement value 5364 in the record is larger than the smallest value of the I/O count actual measurement values 5364 contained in all the records. Specifically, the I/O count normalized value 5366 indicates how many times the I/O count actual measurement value 5364 of the physical path identified by the physical path name 5362 in the record is larger than the smallest value of all the I/O count actual measurement values 5364 of the physical path.

Accordingly, the I/O count normalized value 5366 in the record containing the smallest I/O count actual measurement value 5364 is “1”. Specifically, the I/O count normalized value 5366 of the physical path having the smallest I/O count actual measurement value 5364 is “1”.

In the case of the configuration diagram shown in FIG. 6, a value “5.0” corresponding to the I/O count actual measurement value 5364 of the physical path identified by “b” as the physical path name 5362 is the smallest value. Therefore, the I/O count normalized value 5366 is calculated by dividing the I/O count actual measurement value 5364 in the record by “5.0” corresponding to the smallest value.

The feature 5367 indicates which of the I/O amount and the count of I/Os is taken into greater consideration by the physical path identified by the physical path name 5362 in the record. The physical path which takes the I/O amount into greater consideration can transmit a large I/O amount. Therefore, the physical path which takes the I/O amount into greater consideration is suitable for transmitting the I/Os issued from the task application program 131 taking the I/O amount into greater consideration. On the other hand, the physical path which takes the count of I/Os into greater consideration can transmit a large count of I/Os. Therefore, the physical path which takes the count of I/Os into greater consideration is suitable for transmitting the I/Os issued from the task application program 131 which takes the count of I/Os into greater consideration.

A process in which the management server 5 determines the feature 5367 will be described in detail below with reference to FIG. 8.

FIGS. 7A and 7B are configuration diagrams, each showing the counter value management table 137 stored in the host computer 1 according to the embodiment of the present invention.

The host computer 1 stores the counter value management table 137 corresponding to each of the physical paths connected to the host computer 1. Therefore, the host computer 1 stores the counter value management tables 137 as many as the physical paths connected to the host computer 1.

The counter value management table 137 shown in FIG. 7A corresponds to the physical path identified by the physical path name, “c”, whereas the counter value management table 137 shown in FIG. 7B corresponds to the physical path identified by the physical path name, “d”.

The counter value management table 137 contains a task application name 1371, a feature 1372, a counter upper limit value 1373, and a counter value 1374.

The task application name 1371 is a unique identifier of the task application program 131 installed on the host computer 1. The feature 1372 indicates which of the I/O amount and the count of I/Os is taken into greater consideration by the task application 131 identified by the task application name 1371 in the record.

The counter value 1374 indicates the count of I/Os transmitted from the physical path among the I/Os issued from the task application program 131 identified by the task application name 1371 in the record. Therefore, upon transmission of an I/O from the physical path, which is issued from the task application program 131 identified by the task application name 1371 in the record, the counter value 1374 is incremented.

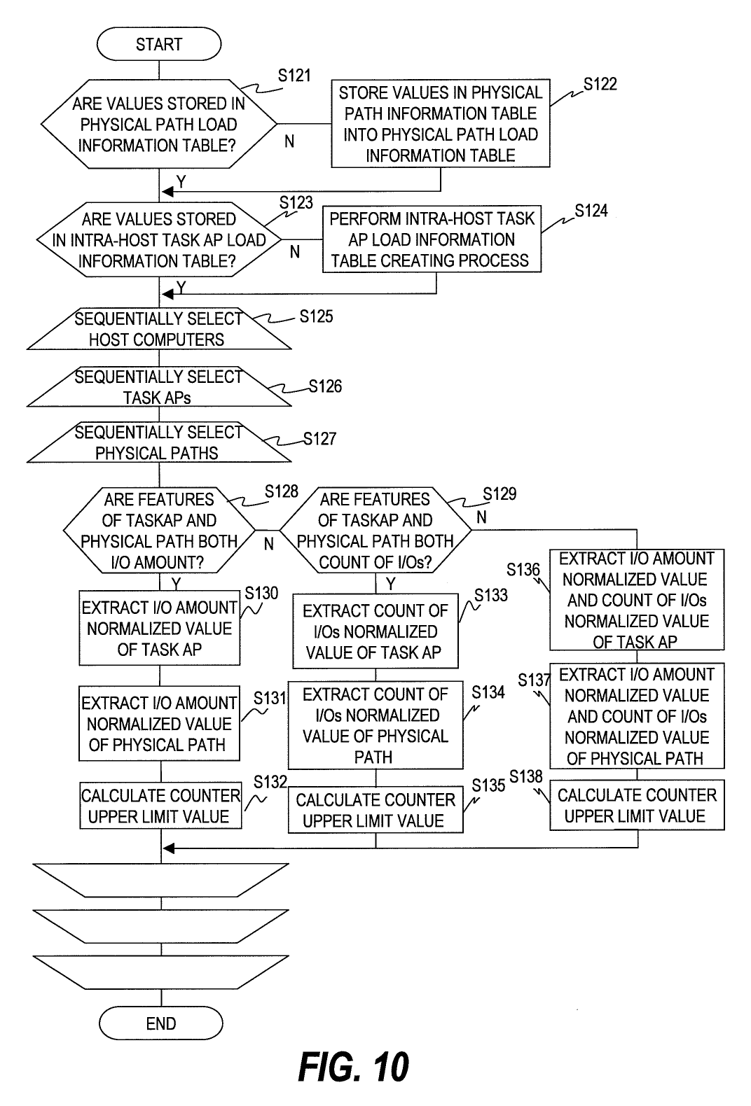

The counter upper limit value 1373 is an upper limit value of the counter value 1374 in the record. Therefore, when the counter value 1374 reaches the counter upper limit value 1373, all the counter values 1374 contained in the counter value management table 137 are reset to “0” corresponding to an initial value. The counter upper limit value 1373 is calculated by any of the management server 5 and the host computer 1. A counter upper limit value calculating process will be described in detail below with reference to FIG. 10.

The host computer 1 determines the order of transmission of the I/Os issued from the task application program 131 based on a counter residual corresponding to a difference between the counter upper limit value 1373 and the counter value 1374. Accordingly, the counter upper limit value 1373 is information (priority) for determining the order of transmission of the I/Os issued from the task application program 131.

FIG. 8 is a flowchart of a feature determining process executed by the management server 5 according to the embodiment of the present invention.

Referring to FIG. 8, the process of determining the feature 5338 contained in the task application load information table 533 will be described.

First, the management server 5 sequentially selects all the records contained in the task application load information table 533 one by one (S101).

Next, the management server 5 extracts the I/O amount normalized value 5336 and the I/O count normalized value 5337 from the selected record. Next, the management server 5 determines whether or not the extracted I/O amount normalized value 5336 is equal to or larger than the extracted I/O count normalized value 5337 (S102).

When the I/O amount normalized value 5336 is equal to or larger than the I/O count normalized value 5337, the management server 5 determines that the task application program 131 takes the I/O amount into greater consideration (S103). Therefore, the management server 5 stores “I/O amount” as the feature 5338 in the selected record. Then, the process proceeds to Step S104.

On the other hand, when the I/O amount normalized value 5336 is less than the I/O count normalized value 5337, the management server 5 determines that the task application program 131 takes the count of I/Os into greater consideration (S105). Therefore, the management server 5 stores “I/O count” as the feature 5338 in the selected record.

Next, the management server 5 determines whether or not all the records contained in the task application load information table 533 have been selected in Step S101 (S104).

When even any one of the records contained in the task application load information table 533 has not been selected, the management server 5 returns to Step S101. Then, the management server 5 selects the unselected record to repeat the process.

On the other hand, when all the records contained in the task application load information table 533 have been selected, the management server 5 terminates the feature determining process.

Next, a process of determining the feature 5367 contained in the physical path load information table 536 will be described.

First, the management server 5 sequentially selects all the records contained in the physical path load information table 536 one by one (S101).

Next, the management server 5 extracts the I/O amount normalized value 5365 and the I/O count normalized value 5366 from the selected record. Next, the management server 5 determines whether or not the extracted I/O amount normalized value 5365 is equal to or larger than the extracted I/O count normalized value 5366 (S102).

When the I/O amount normalized value 5365 is equal to or larger than the I/O count normalized value 5366, the management server 5 determines that the task application program 131 takes the I/O amount into greater consideration (S103). Therefore, the management server 5 stores “I/O amount” as the feature 5367 in the selected record. Then, the process proceeds to Step S104.

On the other hand, when the I/O amount normalized value 5365 is less than the I/O count normalized value 5366, the management server 5 determines that the task application program 131 takes the count of I/Os into greater consideration (S105). Therefore, the management server 5 stores “I/O count” as the feature 5367 in the selected record.

Next, the management server 5 determines whether or not all the records contained in the physical path load information table 536 have been selected in Step S101 (S104).

When even any one of the records contained in the physical path load information table 536 has not been selected, the management server 5 returns to Step S101. Then, the management server 5 selects the unselected record to repeat the process.

On the other hand, when all the records contained in the physical path load information table 536 have been selected, the management server 5 terminates the feature determining process.

FIG. 9 is a flowchart of a data assignment rate determining process executed by the management server 5 according to the embodiment of the present invention.

The management server 5 executes the data assignment rate determining process at predetermined intervals.

First, the management server 5 determines whether or not values are stored in the physical path load information table 536 (S111). When values are stored in the physical path load information table 536, the management server 5 proceeds to Step S113.

On the other hand, when no value is stored in the physical path load information table 536, the management server 5 stores the values, which are stored in the physical path information table 534, in the physical path load information table 536 (S112). Specifically, the values stored in the physical path information table 534 are used as initial values of the physical path load information table 536.

More specifically, the management server 5 stores the I/O amount performance value 5343 in the physical path information table 534 as the I/O amount actual measurement value 5363 in the physical path load information table 536. Next, the management server 5 stores the I/O count performance value 5344 in the physical path information table 534 as the I/O count actual measurement value 5364 in the physical path load information table 536. Next, the management server 5 stores the I/O amount normalized value 5345 in the physical path information table 534 as the I/O amount normalized value 5365 in the physical path load information table 536. Then, the management server 5 stores the I/O count normalized value 5346 in the physical path information table 534 as the I/O count normalized value 5366 in the physical path load information table 536. Furthermore, the management server 5 executes the feature determining process (FIG. 8).

Subsequently, the management server 5 sequentially selects all the records contained in the task application load information table 533 one by one. As a result, the management server 5 sequentially selects all the task application programs 131 installed on any of the host computers 1 included in the computer system one by one (S113). In this step, the management server 5 selects the task application program 131 identified by the task application name 5331 in the selected record.

Next, the management server 5 extracts the host name 5332 and the feature 5338 from the selected record (S114).

Subsequently, the management server 5 sequentially selects all the host computers 1 identified by the extracted host name 5332 one by one (S115). As a result, the management server 5 sequentially selects all the host computers 1, on which the selected task application program 131 is installed, one by one.

Next, the management server 5 determines whether or not the extracted feature 5338 is “I/O amount” (S116). As a result, the management server 5 determines whether or not the selected task application program 131 takes the I/O amount into greater consideration.

When the feature 5338 is “I/O amount”, the management server 5 selects all the records containing the host name 5361 which is identical with the extracted host name 5332 from the physical path load information table 536. Next, the management server 5 extracts the I/O amount normalized values 5365 from all the selected records. Subsequently, the management server 5 adds up all the extracted I/O amount normalized values 5365 (S117).

On the other hand, when the feature 5338 is “I/O count”, the management server 5 selects all the records containing the host name 5361 which is identical with the extracted host name 5332 from the physical path load information table 536. Next, the management server 5 extracts the I/O count normalized values 5366 from all the selected records. Subsequently, the management server 5 adds up all the extracted I/O count normalized values 5366 (S118).

Next, the management server 5 determines whether or not all the host computers 1 identified by the extracted host name 5332 have been selected in Step S115.

When even any one of the host computers 1 identified by the extracted host name 5332 has not been selected, the management server 5 selects the unselected host computer 1 to repeat the process.

On the other hand, when all the host computers 1 identified by the extracted host name 5332 have been selected, the management server 5 determines an assignment rate of the data to be transmitted to the task application program 131 selected in Step S113 based on the sum obtained in Step S117 or S118 (S119). More specifically, the management server 5 determines a ratio of the sums obtained in Step S117 or S118 as an assignment rate of the data to be transmitted to the task application program 131 selected in Step S113.

Next, the management server 5 determines whether or not all the task application programs 131 have been selected in Step S113.

When even any one of the task application programs 131 has not been selected, the management server 5 selects the unselected task application program 131 to repeat the process.

On the other hand, when all the task application programs 131 have been selected, the management server 5 terminates the data assignment rate determining process.

The calculation of an assignment rate of the data processed by the task application program 131 identified by “AP1” will now be described for the case where the physical path load information table 536 is as shown in FIG. 6.

In this case, the management server 5 selects the record containing “AP1” as the task application name 5331 from the task application load information table 533. Next, the management server 5 extracts “HOST1” and “HOST3” corresponding to the host name 5332 from the selected record. Furthermore, the management server 5 extracts “I/O amount” corresponding to the feature 5338 from the selected record.

Next, the management server 5 selects the record containing the host name 5361 which is identical with “HOST1” in the extracted host name 5332 from the physical path load information table 536. Since the extracted feature 5538 is “I/O amount”, the management server 5 extracts “6.42” and “2.86” corresponding to the I/O amount normalized value 5365 from the selected record.

Next, the management server 5 adds up “6.42” and “2.86” corresponding to the extracted I/O amount normalized value 5365 to obtain “9.28” as the sum.

Subsequently, the management server 5 selects the record containing the host name 5361 which is identical with “HOST3” corresponding to the extracted host name 5332 from the physical path load information table 536. Since the extracted feature 5538 is “I/O amount”, the management server 5 extracts “2.29” and “2.57” corresponding to the I/O amount normalized value 5365 from the selected record.

Next, the management server 5 adds up “2.29” and “2.57” corresponding to the extracted I/O amount normalized value 5365 to obtain “4.86” as the sum.

Then, the management server 5 determines an assignment rate of the data transmitted to the task application program 131 identified by “AP1” based on the calculated sums “9.28” and “4.86”. More specifically, the management server 5 determines “HOST1:HOST3=9.28:4.86” as an assignment rate of the data processed by the task application program 131 identified by “AP1”.

FIG. 10 is a flowchart of a counter upper limit values calculating process executed by the management server 5 according to the embodiment of the present invention.

The management server 5 executes the counter upper limit values calculating process at predetermined intervals.

First, the management server 5 determines whether or not values are stored in the physical path load information table 536 (S121). When values are stored in the physical path load information table 536, the management server 5 proceeds to Step S123.

On the other hand, when no value is stored in the physical path load information table 536, the management server 5 stores the values, which are stored in the physical path information table 534, in the physical path load information table 536 (S122). Specifically, the values stored in the physical path information table 534 are used as initial values of the physical path load information table 536.

More specifically, the management server 5 stores the I/O amount performance value 5343 in the physical path information table 534 as the I/O amount actual measurement value 5363 in the physical path load information table 536. Next, the management server 5 stores the I/O count performance value 5344 in the physical path information table 534 as the I/O count actual measurement value 5364 in the physical path load information table 536. Next, the management server 5 stores the I/O amount normalized value 5345 in the physical path information table 534 as the I/O amount normalized value 5365 in the physical path load information table 536. Then, the management server 5 stores the I/O count normalized value 5346 in the physical path information table 534 as the I/O count normalized value 5366 in the physical path load information table 536. Furthermore, the management server 5 executes the feature determining process (FIG. 8).

Next, the management server 5 determines whether or not values are stored in the intra-host task application load information table 535 (S123). When values are stored in the intra-host task application load information table 535, the management server 5 proceeds to Step S125.

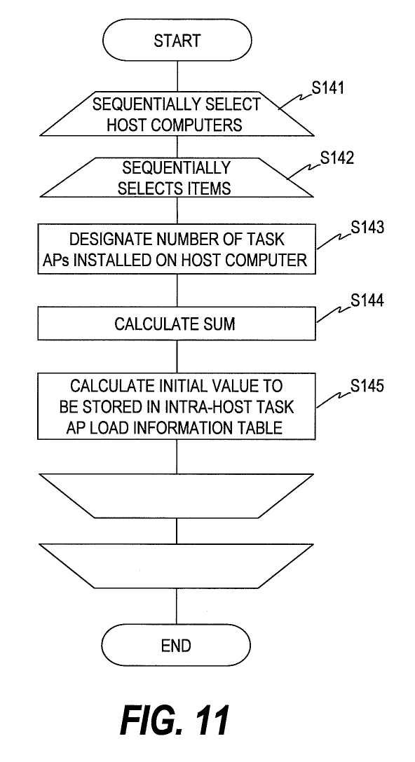

On the other hand, when no value is stored in the intra-host task application load information table 535, the management server 5 executes an intra-host task application load information table creating process (S124). The intra-host task application load information table creating process will be described in detail below with reference to FIG. 11.

Next, the management server 5 sequentially selects all the host computers 1 included in the computer system one by one (S125).

Next, the management server 5 selects the record containing the host name 5321 which is identical with the identifier of the selected host computer 1 from the host information table 532. Next, the management server 5 extracts the task application name 5322 and the physical path name 5323 from the selected record.

Subsequently, the management server 5 sequentially selects all the task application programs 131 identified by the extracted task application name 5322 one by one (S126). As a result, the management server 5 sequentially selects all the task application programs 131 installed on the selected host computer 1 one by one.

Next, the management server 5 sequentially selects all the physical paths identified by the extracted physical path name 5323 one by one (S127). In this manner, the management server 5 sequentially selects all the physical paths connected to the selected host computer 1 one by one.

Next, the management server 5 selects the record containing the task application name 5331 which is identical with the identifier of the selected task application program 131 from the task application load information table 533. Subsequently, the management server 5 extracts the feature 5338 from the selected record.

Then, the management server 5 selects the record containing the physical path name 5362 which is identical with the identifier of the selected physical path from the physical path load information table 536. Next, the management server 5 extracts the feature 5367 from the selected record.

Next, the management server 5 determines whether or not the extracted feature 5338 and feature 5367 are “I/O amount”. In this manner, the management server 5 determines whether or not the feature of the selected task application program 131 and the feature of the selected physical path are both “I/O amount” (S128).

When the feature 5338 and the feature 5367 are both “I/O amount”, the management server 5 selects the record containing the host name 5351 which is identical with the identifier of the selected host computer 1 from the intra-host task application load information table 535. Next, the management server 5 selects the record containing the task application name 5352 in the intra-host task application load information table 535, which is identical with the identifier of the selected task application program 131, from the selected records.

Next, the management server 5 extracts the I/O amount normalized value 5355 from the selected record. In this manner, the management server 5 extracts the I/O amount normalized value 5355 of the selected task application program 131 (S130).

Next, the management server 5 extracts the I/O amount normalized value 5365 from the record selected from the physical path load information table 536. In this manner, the management server 5 extracts the I/O amount normalized value 5365 of the selected physical path (S131).

Next, the management server 5 selects all the records containing the host name 5361 which is identical with the identifier of the selected host computer 1 from the physical path load information table 536. Subsequently, the management server 5 extracts the I/O amount normalized values 5365 from all the selected records. Then, the management server 5 adds up all the extracted I/O amount normalized values 5365. In this manner, the management server 5 calculates the sum of the I/O amount normalized values 5365 of all the physical paths connected to the selected host computer 1.

Next, the management server 5 uses Formula (1) to calculate the counter upper limit value 1373 (C1) in the record corresponding to the selected task application program 131 among the records contained in the counter value management table 137, which correspond to the selected physical path (S132).

C1=V1×R1×2÷R1ₐₗₗ (1)

where V1 is the I/O amount normalized value 5355 extracted in Step S130, specifically, the I/O amount normalized value 5355 of the selected task application program 131, R1 is the I/O amount normalized value 5365 extracted in Step S131, specifically, the I/O amount normalized value 5365 of the selected physical path, and R1ₐₗₗ is the calculated sum, specifically, the sum of the I/O amount normalized values 5365 of all the physical paths connected to the selected host computer 1.

On the other hand, when at least one of the features 5338 and 5367 is not “I/O amount”, the management server 5 determines whether or not the features 5338 and 5367 are “I/O count”. In this manner, the management server 5 determines whether or not the feature of the selected task application program 131 and the feature of the selected physical path are both “I/O count” (S129).

When the feature 5338 and the feature 5367 are both “I/O count”, the management server 5 selects the record containing the host name 5351 which is identical with the identifier of the selected host computer 1 from the intra-host task application load information table 535. Next, the management server 5 selects the record containing the task application name 5352 in the intra-host task application load information table 535, which is identical with the identifier of the selected task application program 131, from the selected records.

Next, the management server 5 extracts the I/O count normalized value 5356 from the selected record. In this manner, the management server 5 extracts the I/O count normalized value 5356 of the selected task application program 131 (S133).

Next, the management server 5 extracts the I/O count normalized value 5366 from the record selected from the physical path load information table 536. In this manner, the management server 5 extracts the I/O count normalized value 5366 from the selected physical path (S134).

Next, the management server 5 selects all the records containing the host name 5361 which is identical with the identifier of the selected host computer 1 from the physical path load information table 536. Subsequently, the management server 5 extracts the I/O count normalized values 5366 from all the selected records. Then, the management server 5 adds up all the extracted I/O count normalized values 5366. In this manner, the management server 5 calculates the sum of the I/O count normalized values 5366 of all the physical paths connected to the selected host computer 1.

Next, the management server 5 uses Formula (2) to calculate the counter upper limit value 1373 (C2) in the record corresponding to the selected task application program 131 among the records contained in the counter value management table 137, which correspond to the selected physical path (S135).

C2=V2×R2×2÷R2ₐₗₗ (2)

where V2 is the I/O count normalized value 5356 extracted in Step S133, specifically, the I/O count normalized value 5356 of the selected task application program 131, R2 is the I/O count normalized value 5366 extracted in Step S134, specifically, the I/O count normalized value 5366 of the selected physical path, and R2ₐₗₗ is the calculated sum, specifically, the sum of the I/O count normalized values 5366 of all the physical paths connected to the selected host computer 1.

On the other hand, when at least one of the features 5338 and 5367 is not “I/O count”, the features 5338 and 5367 differ from each other. In this case, the management server 5 selects the records containing the host name 5351 which is identical with the identifier of the selected host computer 1 from the intra-host task application load information table 535. Next, the management server 5 selects the record containing the task application name 5352 in the intra-host task application load information table 535 which is identical with the identifier of the selected task application program 131 from the selected records.

Next, the management server 5 extracts the I/O amount normalized value 5355 and the I/O count normalized value 5356 from the selected record. In this manner, the management server 5 extracts the I/O amount normalized value 5355 and the I/O count normalized value 5356 of the selected task application program 131 (S136).

Next, the management server 5 extracts the I/O amount normalized value 5365 and the I/O count normalized value 5366 from the record selected from the physical path load information table 536. In this manner, the management server 5 extracts the I/O amount normalized value 5365 and the I/O count normalized value 5366 of the selected physical path (S137).

Subsequently, the management server 5 selects all the records containing the host name 5361 which is identical with the identifier of the selected host computer 1 from the physical path load information table 536.

Next, the management server 5 extracts the I/O amount normalized values 5365 and the I/O count normalized values 5366 from all the selected records. Then, the management server 5 adds up all the extracted I/O amount normalized values 5365. In this manner, the management server 5 calculates the sum of the I/O amount normalized values 5365 of all the physical paths connected to the selected host computer 1.

Next, the management server 5 adds up all the extracted I/O count normalized values 5366. In this manner, the management server 5 calculates the sum of the I/O count normalized values 5366 of all the physical paths connected to the selected host computer 1.

Next, the management server 5 uses Formula (3) to calculate the counter upper limit value 1373 (C3) in the record corresponding to the selected task application program 131 among the records contained in the counter value management table 137, which correspond to the selected physical path (S138).

C3=V1×R1÷R1ₐₗₗ+V2×R2÷R2ₐₗₗ (3)

where V1 is the I/O amount normalized value 5355 extracted in Step S136, specifically, the I/O amount normalized value 5355 of the selected task application program 131, R1 is the I/O amount normalized value 5365 extracted in Step S137, specifically, the I/O amount normalized value 5365 of the selected physical path, and R1ₐₗₗ is the calculated sum, specifically, the sum of the I/O amount normalized values 5365 of all the physical paths connected to the selected host computer 1.

V2 is the I/O count normalized value 5356 extracted in Step S136, specifically, the I/O count normalized value 5356 of the selected task application program 131, R2 is the I/O count normalized value 5366 extracted in Step S137, specifically, the I/O count normalized value 5366 of the selected physical path, and R2ₐₗₗ is the calculated sum, specifically, the sum of the I/O count normalized values 5366 of all the physical paths connected to the selected host computer 1.

After the calculation of the counter upper limit value 1373, the management server 5 determines whether or not all the physical paths identified by the extracted physical path name 5323 have been selected in Step S127.

When even any one of the physical paths identified by the extracted physical path name 5323 has not been selected, the management server 5 selects the unselected physical path to repeat the process.

On the other hand, when all the physical paths identified by the extracted physical path name 5323 have been selected, the management server 5 determines whether or not all the task application programs 131 identified by the extracted task application name 5322 have been selected in Step S126.

When even any one of the task application programs 131 identified by the extracted task application name 5322 has not been selected, the management server 5 selects the unselected task application program 131 to repeat the process.

On the other hand, when all the task application programs 131 identified by the extracted task application name 5322 have been selected, the management server 5 determines whether or not all the host computers 1 have been selected in Step S125.

When even any one of the host computers 1 has not been selected, the management server 5 selects the unselected host computer 1 to repeat the process.

On the other hand, when all the host computers 1 have been selected, the management server 5 terminates the counter upper limit value calculating process.

The management server 5 is required to correct all the counter upper limit values calculated in the counter upper limit value calculating process to integers. The management server 5 may correct the counter upper limit values to integers by any method.

For example, the management server 5 corrects the counter upper limit value to an integer by rounding off, rounding up or rounding down after the decimal points of the calculated counter upper limit value. Alternatively, the management server 5 multiplies the calculated counter upper limit value by an appropriate value to correct the counter upper limit value to an integer.

FIG. 11 is a flowchart of the intra-host task application load information table creating process executed by the management server 5 according to the embodiment of the present invention.

The intra-host task application load information table creating process is executed in Step S124 of the counter upper limit value calculating process (FIG. 10).

First, the management server 5 sequentially selects all the host computers 1 included in the computer system one by one (S141).

Next, the management server 5 sequentially selects any of the I/O amount normalized value 5345 and the I/O count normalized value 5346 contained in the physical path information table 534 (S142).

First, it is assumed that the management server 5 selects the I/O amount normalized value 5345.

In this case, the management server 5 selects the record containing the host name 5321 which is identical with the identifier of the selected host computer 1 from the host information table 532. Next, the management server 5 designates the number of identifiers stored as the task application name 5322 in the selected record. In this manner, the management server 5 designates the number of the task application programs 131 installed on the selected host computer 1 (S143).

Next, the management server 5 selects all the records containing the host name 5341 which is identical with the identifier of the selected host computer 1 from the physical path information table 534. Subsequently, the management server 5 extracts the I/O amount normalized values 5345 from all the selected records. Next, the management server 5 adds up the extracted I/O amount normalized values 5345 (S144).

Next, the management server 5 divides the calculated sum by the designated number of the task application programs 131 to calculate an initial value of the I/O amount normalized value of the task application program 131 (S145). The initial values of the I/O amount normalized values of all the task application programs 131 installed on the same host computer 1 are the same.

Next, the management server 5 updates the intra-host task application load information table 535. More specifically, the management server 5 selects all the records containing the host name 5351 which is identical with the identifier of the selected host computer 1 from the intra-host task application load information table 535. Next, the management server 5 stores the calculated initial value in the I/O amount normalized values 5355 in all the selected records.

Subsequently, it is assumed that the management server 5 selects the I/O count normalized value 5346.

In this case, the management server 5 selects the record containing the host name 5321 which is identical with the identifier of the selected host computer 1 from the host information table 532. Next, the management server 5 designates the number of identifiers stored as the task application name 5322 in the selected record. In this manner, the management server 5 designates the number of the task application programs 131 installed on the selected host computer 1 (S143).

Next, the management server 5 selects all the records containing the host name 5341 which is identical with the identifier of the selected host computer 1 from the physical path information table 534. Subsequently, the management server 5 extracts the I/O count normalized values 5346 from all the selected records. Next, the management server 5 adds up the extracted I/O count normalized values 5346 (S144).

Next, the management server 5 divides the calculated sum by the designated number of the task application programs 131 to calculate an initial value of the I/O count normalized value of the task application program 131 (S145). The initial values of the I/O count normalized values of all the task application programs 131 installed on the same host computer 1 are the same.

Next, the management server 5 updates the intra-host task application load information table 535. More specifically, the management server 5 selects all the records containing the host name 5351 which is identical with the identifier of the selected host computer 1 from the intra-host task application load information table 535. Next, the management server 5 stores the calculated initial value in the I/O count normalized values 5356 in all the selected records.

Subsequently, the management server 5 determines whether or not all the host computers 1 have been selected in Step S141.

When even any one of the host computers 1 has not been selected, the management server 5 selects the unselected host computer 1 to repeat the process.

On the other hand, when all the host computers 1 have been selected, the management server 5 terminates the intra-host task application load information table creating process.

FIG. 12 is a flowchart of an I/O transmitting process executed by the host computer 1 according to the embodiment of the present invention.

The host computer 1 executes the I/O transmitting process for each of the physical paths connected to the host computer 1. In the I/O transmitting process, the counter value management table 137 corresponding to the physical path to be processed is used.

First, the host computer 1 selects all the queues storing the I/Os from the queues included in the host computer 1 (S151).

Next, the host computer 1 selects the record containing the task application name 1371 which is identical with the identifier of the task application program 131 corresponding to the selected queue from the counter value management table 137. Next, the host computer 1 extracts the counter upper limit value 1373 and the counter value 1374 from the selected record. Subsequently, the host computer 1 subtracts the extracted counter value 1374 from the extracted counter upper limit value 1373. In this manner, the host computer 1 calculates a counter residual for each of the selected queues.

Subsequently, the host computer 1 selects the queue having the largest counter residual obtained by the calculation, from all the selected queues. When a plurality of queues has the largest counter residual, the host computer 1 selects one from the queues having the largest counter residual by an arbitrary method.

Next, the host computer 1 obtains the I/O from the selected queue (S152). Then, the host computer 1 transmits the obtained I/O by using the physical path (S153).

Next, the host computer 1 selects the record containing the task application name 137 which is identical with the identifier of the task application program 131 corresponding to the queue, from which the I/O is obtained, from the counter value management table 137. Subsequently, the host computer 1 increments the counter value 1374 in the selected record. In this manner, the host computer 1 increments the counter value 1374 of the queue from which the I/O is obtained (S154).

Subsequently, the host computer 1 determines whether or not the incremented counter value 1374 has reached the counter upper limit value 1373 in the selected record (S155). In this manner, the host computer 1 determines whether or not the counter value 1374 of the queue, from which the I/O is obtained, has reached the counter upper limit value 1373.

When the counter value 1374 has not reached the counter upper limit value 1373, the host computer 1 proceeds to Step S157.

On the other hand, when the counter value 1374 has reached the counter upper limit value 1373, the host computer 1 resets the counter values 1374 in all the records contained in the counter value management table 137 to “0” corresponding to an initial value (S156).

Next, the host computer 1 determines whether or not there is any queue storing the I/O (S157). When there is no queue storing the I/O, the host computer 1 waits until the I/O is stored in any of the queues.

On the other hand, when there is any queue storing the I/O, the host computer 1 returns to Step S151 to repeat the I/O transmitting process.

In this embodiment, the host computer 1 measures the characteristic of the task application program 131 and the characteristic of the physical path. Then, the host computer 1 transmits the measured characteristics of the task application program 131 and the physical path to the management server 5. The management server 5 determines the counter upper limit value of the queue included in the host computer 1 based on the received characteristics of the task application program 131 and the physical path.

The host computer 1 sequentially transmits the I/Os stored in the queues having larger counter residuals. The counter residual corresponds to a difference between the counter upper limit value and the counter value. Specifically, the host computer 1 determines the order of transmission of I/Os based on the counter upper limit value which is determined based on the characteristics of the task application program 131 and the physical path. Therefore, the host computer 1 determines the order of transmission of I/Os according to the characteristics of the task application program 131 and the physical path.

Moreover, based on the characteristics of the task application program 131 and the physical path, the management server 5 determines to which host computer 1 and at what rate the data processed by the task application program 131 is assigned. As a result, the management server 5 can suitably balance the loads on the host computers 1 and the physical paths.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
a plurality of host computers, each including a processor, a memory, and an interface;
at least one storage system coupled to the plurality of host computers through a plurality of paths; and
a management computer including a processor, a memory, and an interface,
the management computer being able to access the plurality of host computers, wherein:
each of the plurality of host computers executes at least one application program that issues an I/O to the storage system; and
the management computer obtains a characteristic of the application program and a characteristic of the path from the plurality of host computers, and calculates a rate of assignment of data processed by the application program to each of the plurality of host computers based on the obtained characteristic of the application program and the obtained characteristic of the path.

2. The computer system according to claim 1, wherein:
the characteristic of the application program includes an I/O amount and the count of I/Os issued from the application program; and
the characteristic of the path includes an I/O amount and the count of I/Os transmitted by using the path.

3. The computer system according to claim 2, wherein:
the management computer determines which of the I/O amount and the count of I/Os is taken into greater consideration by the application program based on the obtained characteristic of the application program;
the management computer calculates the I/O amount transmitted by using all the paths coupled to the host computers for each of the plurality of host computers based on the characteristic of the path, and calculates the rate of assignment of the data processed by the application program to each of the plurality of host computers based on a rate of the I/O amount calculated for each of the plurality of host computers, when the application program takes the I/O amount into greater consideration; and
the management computer calculates the count of I/Os transmitted by using all the paths coupled to the host computer for each of the plurality of host computers based on the characteristic of the path, and calculates the rate of assignment of the data processed by the application program to each of the plurality of host computers based on a rate of the count of the I/Os calculated for each of the plurality of host computers, when the application program takes the count of I/Os into greater consideration.

4. The computer system according to claim 1, wherein the management computer calculates, for each of the application programs, priority for determining the order of transmission of the I/Os issued from the application program by using the path based on the obtained characteristics of the application program and the path.

5. The computer system according to claim 4, wherein:
the priority comprises a counter upper limit value; and
the host computer sets, for each of the application programs, a counter value indicating the count of the I/Os issued from the application program by using the path, transmits the I/Os issued from the application programs in the order of the application programs having larger differences between the counter upper limit values and the counter values by using the path, and resets the counter values set for all the application programs to an initial value when the counter value reaches the counter upper limit value.

6. The computer system according to claim 5, wherein:
the characteristic of the application program includes an I/O amount and the count of I/Os issued from the application program;
the characteristic of the path includes an I/O amount and the count of I/Os transmitted by using the path;
the management computer determines which of the I/O amount and the count of I/Os is taken into greater consideration by the application program based on the obtained characteristic of the application program;
the management computer determines which of the I/O amount and the count of I/Os is taken into greater consideration by the path based on the obtained characteristic of the path;
the management computer calculates the counter upper limit value based on the I/O amount issued from the application program and the I/O amount transmitted by using the path when each of the application program and the path takes the I/O amount into greater consideration;
the management computer calculates the counter upper limit value based on the count of the I/Os issued from the application program and the count of the I/Os transmitted by using the path when each of the application program and the path takes the count of the I/Os into greater consideration; and
the management computer calculates the counter upper limit value based on the I/O amount and the count of the I/Os issued from the application program and the I/O amount and the count of the I/Os transmitted by using the path when one of the application program and the path takes the I/O amount into greater consideration whereas another one of the application program and the path takes the count of the I/Os into greater consideration.

7. A load balancing method in a computer system,
the computer system comprising:
a plurality of host computers, each including a processor, a memory, and an interface;
at least one storage system coupled to the plurality of host computers through a plurality of paths; and
a management computer including a processor, a memory, and an interface,
the management computer being able to access the plurality of host computers,
the load balancing method comprising the steps of:
executing, by each of the plurality of host computers, at least one application program that issues an I/O to the storage system;
obtaining, by the management computer, a characteristic of the application program and a characteristic of the path from the plurality of host computers; and
calculating, by the management computer, a rate of assignment of data processed by the application program to each of the plurality of host computers based on the obtained characteristic of the application program and the obtained characteristic of the path.

8. The load balancing method according to claim 7, wherein:
the characteristic of the application program includes an I/O amount and the count of I/Os issued from the application program; and
the characteristic of the path includes an I/O amount and the count of I/Os transmitted by using the path.

9. The load balancing method according to claim 8, further comprising the steps of:
determining, by the management computer, which of the I/O amount and the count of the I/Os is taken into greater consideration by the application program based on the obtained characteristic of the application program; and
calculating, by the management computer, the I/O amount transmitted by using all the paths coupled to the host computer for each of the plurality of host computers based on the characteristic of the path when the application program takes the I/O amount into greater consideration,
wherein the process of calculating the assignment rate includes calculating the rate of assignment of the data processed by the application program to each of the plurality of host computers based on a rate of the I/O amount calculated for each of the host computers.

10. The load balancing method according to claim 8, further comprising the steps of:
determining, by the management computer, which of the I/O amount and the count of I/Os is taken into greater consideration by the application program based on the obtained characteristic of the application program; and
calculating, by the management computer, the count of the I/Os transmitted by using all the paths coupled to the host computers for each of the plurality of host computers based on the characteristic of the path when the application program takes the count of the I/Os into greater consideration;
wherein the process of calculating the assignment rate includes calculating the rate of assignment of the data processed by the application program to each of the plurality of host computers based on a rate of the I/O amount calculated for each of the host computers.

11. The load balancing method according to claim 7, further comprising the steps of calculating, by the management computer, for each of the application programs, priority for determining the order of transmission of the I/Os issued from the application program by using the path based on the obtained characteristics of the application program and the path.

12. The load balancing method according to claim 11, wherein:
the priority comprises a counter upper limit value; and
the load balancing method further comprises the steps of:
setting, by the host computer, for each of the application programs, a counter value indicating the count of the I/Os issued from the application program by using the path;
transmitting, by the host computer, the I/Os issued from the application programs in the order of the application programs having larger differences between the counter upper limit values and the counter values by using the path; and
resetting, by the host computer, the counter values set for all the application programs to an initial value when the counter value reaches the counter upper limit value.

13. The load balancing method according to claim 12, wherein:
the characteristic of the application program includes an I/O amount and the count of I/Os issued from the application program;
the characteristic of the path includes an I/O amount and the count of I/Os transmitted by using the path;
the load balancing method further comprises the steps of:
determining, by the management computer, which of the I/O amount and the count of I/Os is taken into greater consideration by the application program based on the obtained characteristic of the application program;
determining, by the management computer, which of the I/O amount and the count of I/Os is taken into greater consideration by the path based on the obtained characteristic of the path; and
the step of calculating priority includes:
calculating the counter upper limit value based on the I/O amount issued from the application program and the I/O amount transmitted by using the path when each of the application program and the path takes the I/O amount into greater consideration;
calculating the counter upper limit value based on the count of the I/Os issued from the application program and the count of the I/Os transmitted by using the path when each of the application program and the path takes the count of the I/Os into greater consideration; and
calculating the counter upper limit value based on the I/O amount and the count of the I/Os issued from the application program and the I/O amount and the count of the I/Os transmitted by using the path when one of the application program and the path takes the I/O amount into greater consideration whereas another one of the application program and the path takes the count of the I/Os into greater consideration.

14. A management computer capable of accessing a plurality of host computers coupled to at least one storage system through a plurality of path, each of the host computers executing at least one application program that issues an I/O to the storage system, wherein:
the management computer obtains a characteristic of the application program and a characteristic of the path from the plurality of host computers; and
the management computer calculates a rate of assignment of data processed by the application program to each of the plurality of host computers based on the obtained characteristic of the application program and the obtained characteristic of the path.

15. The management computer according to claim 14, wherein:
the characteristic of the application program includes an I/O amount and the count of I/Os issued from the application program; and
the characteristic of the path includes an I/O amount and the count of I/Os transmitted by using the path.

16. The management computer according to claim 15, wherein:
the management computer determines which of the I/O amount and the count of I/Os is taken into greater consideration by the application program based on the obtained characteristic of the application program;
the management computer calculates the I/O amount transmitted by using all the paths coupled to the host computers for each of the plurality of host computers based on the characteristic of the path, and calculates, based on a rate of the I/O amount calculated for each of the plurality of host computers, the rate of assignment of the data processed by the application program to each of the plurality of host computers, when the application program takes the I/O amount into greater consideration; and
the management computer calculates the count of I/Os transmitted by using all the paths coupled to the host computer for each of the plurality of host computers based on the characteristic of the path, and calculates the rate of assignment of the data processed by the application program to each of the plurality of host computers based on a rate of the count of the I/Os calculated for each of the plurality of host computers, when the application program takes the count of I/Os into greater consideration.

17. The management computer according to claim 14, wherein the management computer calculates, for each of the application programs, priority for determining the order of transmission of the I/Os issued from the application program by using the path based on the obtained characteristics of the application program and the path.

18. The management computer according to claim 17, wherein:
the characteristic of the application program includes an I/O amount and the count of I/Os issued from the application program;
the characteristic of the path includes an I/O amount and the count of I/Os transmitted by using the path;
the management computer determines which of the I/O amount and the count of I/Os is taken into greater consideration by the application program based on the obtained characteristic of the application program;
the management computer determines which of the I/O amount and the count of I/Os is taken into greater consideration by the path based on the obtained characteristic of the path;
the management computer calculates the priority based on the I/O amount issued from the application program and the I/O amount transmitted by using the path when each of the application program and the path takes the I/O amount into greater consideration;
the management computer calculates the priority based on the count of the I/Os issued from the application program and the count of the I/Os transmitted by using the path when each of the application program and the path takes the count of the I/Os into greater consideration; and
the management computer calculates the priority based on the I/O amount and the count of the I/Os issued from the application program and the I/O amount and the count of the I/Os transmitted by using the path when one of the application program and the path takes the I/O amount into greater consideration whereas another one of the application program and the path takes the count of the I/Os into greater consideration.
